(19) United States
(12) Patent Application Publication
(10) Pub. No.: US 2003/0217773 A1
(43) Pub. Date: Nov. 27, 2003

(54) Hydrogen supply system and control method therefor

(75) Inventors: Tomoji Yamada, Kariya-shi (JP); Yasuhiro Nonobe, Nishikamo-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: Toyota Jidosha Kabushiki Kaisha, Toyota-shi (JP); NIPPON SOKEN, INC., Nishio-shi (JP)

(21) Appl. No.: 10/442,248

(22) Filed: May 21, 2003

(30) Foreign Application Priority Data
May 21, 2002 (JP) 2002-146216

(51) Int. Cl. H01M 8/04

(52) U.S. Cl. 137/565.33; 429/22

(57) ABSTRACT

In a hydrogen supply system, a hydrogen-containing gas is circulated by a circulating pump if a requested hydrogen gas circulation amount VH is less than or equal to a first circulation amount V1. If the requested hydrogen gas circulation amount exceeds the first circulation amount V1, a first control valve is opened so that the circulation amount V1 of hydrogen-containing gas is circulated by a first ejector, and in addition, a circulation amount of hydrogen-containing gas equal to the difference between the circulation amount V1 and the requested hydrogen gas circulation amount VH is circulated by the circulating pump. If the requested hydrogen gas circulation amount exceeds a circulation amount V2, a second control valve is opened in addition to the first control valve so that the circulation amount V2 of hydrogen-containing gas is circulated by the first and second ejectors, and in addition, a circulation amount of hydrogen-containing gas equal to the difference between the circulation amount V2 and the requested hydrogen gas circulation amount VH is circulated by the circulating pump provided that the requested hydrogen gas circulation amount VH is at most a circulation amount V3.

### INCORPORATION BY REFERENCE

The disclosure of Japanese Patent Application No. 2002-146216 filed on May 21, 2002 including the specification, drawings and abstract is incorporated herein by reference in its entirety.

### BACKGROUND OF THE INVENTION

1. Field of the Invention

The invention relates to a hydrogen supply system for supplying hydrogen from a high-pressure hydrogen gas source to a hydrogen-consuming device, and a control method for the system.

2. Description of the Related Art

In systems for supplying pure hydrogen to a hydrogen-consuming device, such as a fuel cell or the like, a technology has been developed for actual use in which a high-pressure hydrogen tank storing hydrogen gas in a high-pressure state is employed as a source for supplying hydrogen gas. In such a system, hydrogen gas stored in the high-pressure hydrogen tank is depressurized to an appropriate pressure via a pressure reducing valve before being supplied to a fuel electrode of a fuel cell.

A hydrogen-containing gas that contains residual hydrogen that has remained unconsumed by the fuel electrode of the fuel cell is supplied again to the fuel electrode side together with newly supplied hydrogen gas, via a circulating pump. This eliminates problems of closure of flow channels in the fuel cell caused by water generated in connection with electric power generation, and the like, so that a good electric power generation state can be maintained.

However, the amount of electric power consumed by the circulating pump for circulating hydrogen-containing gas is unigonorably great in comparison with the amount of electric power generated by the fuel cell. Therefore, there is a demand for a reduction in the amount of electric power consumed for the circulation. Furthermore, a great amount of energy is used to charge hydrogen gas into a high-pressure hydrogen tank. However, at the time of extraction of hydrogen gas from the high-pressure hydrogen tank, energy stored by the hydrogen gas is released in the form of thermal energy as the gas is depressurized. Hence, there is a demand for improved energy efficiency of the entire system that includes the hydrogen gas supply source.

### SUMMARY OF THE INVENTION

The invention has been accomplished in order to solve the aforementioned problems. It is an object of the invention to reduce the power consumed for circulation of hydrogen-containing gas in a hydrogen supply system that employs a high-pressure hydrogen gas storage.

A hydrogen supply system in accordance with an aspect of the invention includes: a hydrogen-consuming device; a high-pressure hydrogen gas storage that stores a hydrogen gas in a high-pressure state; a hydrogen gas passage that conducts the hydrogen gas discharged from the high-pressure hydrogen gas storage to the hydrogen-consuming device; a first circulation passage that is connected to the hydrogen gas passage, and that comprises a part of the hydrogen gas passage, and that conducts a hydrogen-containing gas that contains residual hydrogen not consumed by the hydrogen-consuming device back to the hydrogen-consuming device; a mechanical pump that moves the hydrogen-containing gas in the first circulation passage; a second circulation passage that is connected to the hydrogen gas passage, and that conducts a hydrogen-containing gas that contains residual hydrogen not consumed by the hydrogen-consuming device back to the hydrogen-consuming device; a momentum transfer type vacuum pump that moves the hydrogen-containing gas in the second circulation passage by utilizing the hydrogen gas discharged from the high-pressure hydrogen gas storage as a drive flow; and a control unit that controls a state of operation of the mechanical pump and a state of operation of the momentum transfer type vacuum pump in accordance with an amount of hydrogen consumed by the hydrogen-consuming device.

A hydrogen supply system in accordance with an another aspect of the invention includes: a hydrogen-consuming device having a hydrogen gas supply opening and a residual hydrogen gas discharge opening for discharging a hydrogen-containing gas that contains residual hydrogen not consumed; a high-pressure hydrogen gas storage that stores a hydrogen gas in a high-pressure state; a hydrogen gas supply pipe that connects the high-pressure hydrogen gas storage and the hydrogen gas supply opening of the hydrogen-consuming device; a first hydrogen gas circulation pipe that is connected to the hydrogen gas supply pipe, and that connects the residual hydrogen gas discharge opening of the hydrogen-consuming device and the hydrogen gas supply pipe; a mechanical pump that is disposed on the hydrogen gas supply pipe and that moves a fluid in the first hydrogen gas circulation pipe and the hydrogen gas supply pipe; a second hydrogen gas circulation pipe that is disposed in parallel to the first hydrogen gas circulation pipe and that connects the hydrogen gas supply pipe and the residual hydrogen gas discharge opening of the hydrogen-consuming device; a momentum transfer type vacuum pump that is disposed on the second hydrogen gas circulation pipe and that moves a fluid in the second hydrogen gas circulation pipe and the hydrogen gas supply pipe by utilizing the hydrogen gas discharged from the high-pressure hydrogen gas storage as a drive flow; and a control unit that controls a state of operation of the mechanical pump and a state of operation of the momentum transfer type vacuum pump in accordance with an amount of hydrogen consumed by the hydrogen-consuming device.

In accordance with another aspect of the invention, there is provided control method for a hydrogen supply system that has; a hydrogen-consuming device; a high-pressure hydrogen gas storage that stores a hydrogen gas in a high-pressure state; a first circulation passage, a second circulation passage and a third circulation passage that conduct a hydrogen-containing gas that contains residual hydrogen not consumed by the hydrogen-consuming device back to the hydrogen-consuming device; a first operating fluid introducing pipe that connects the second circulation passage and the high-pressure hydrogen gas storage; a first control valve disposed on the first operating fluid introducing pipe; a second operating fluid introducing pipe that connects the third circulation passage and the high-pressure hydrogen gas storage. The control method includes: the step of calculating a hydrogen consumption amount consumed by the hydrogen-consuming device; the step of comparing the calculated hydrogen consumption amount with a maximum circulation amount of the second circulation passage whose energy consumption for circulating the hydrogen-containing gas is less than an energy consumption for circulating the hydrogen-containing gas of the first circulation passage; the step of allowing at least a flow in the second circulation passage regardless of the maximum circulation amount of the first circulation passage, if a result of the comparison is that the hydrogen consumption amount is equal to or greater than the maximum circulation amount of the second circulation passage.

The control method includes: the step of calculating a hydrogen consumption amount consumed by the hydrogen-consuming device; the step of comparing the hydrogen consumption amount calculated with a maximum circulation amount of the second circulation passage whose energy consumption for circulating the hydrogen-containing gas is less than an energy consumption for circulating the hydrogen-containing gas of the first circulation passage and a maximum circulation amount of the third circulation passage whose energy consumption for circulating the hydrogen-containing gas is less than an energy consumption for circulating the hydrogen-containing gas of the first circulation passage, and whose the maximum circulation amount of the third circulation passage is greater than the maximum circulation amount of the second circulation passage; the step of allowing a flow in at least the second circulation passage, if a result of the comparison is that the hydrogen consumption amount is greater than the maximum circulation amount of the second circulation passage, and is less than or equal to the maximum circulation amount of the third circulation passage; the step of allowing a flow in at least one of the second circulation passage and the third circulation passage, if a result of the comparison is that the hydrogen consumption amount is greater than the maximum circulation amount of the third circulation passage; and the step of allowing a flow in at least the second circulation passage and the third circulation passage, if a result of the comparison is that the hydrogen consumption amount is greater than a total of the maximum circulation amount of the second circulation passage and the maximum circulation amount of the third circulation passage.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a schematic diagram illustrating a construction of a hydrogen supply system in accordance with an embodiment of the invention;

FIG. 2 is a graph indicating a relationship between the requested output of a fuel cell and the amount of hydrogen gas circulation;

FIG. 3 is a timing chart indicating drive signals output from a control unit to a circulating pump and control valves corresponding to the requested amount of hydrogen gas circulation; and

FIG. 4 is a flowchart illustrating a process routine of changing the states of operation of the circulating pump and first and second ejectors in the hydrogen supply system of the embodiment.

### DETAILED DESCRIPTION OF THE PREFERRED EMBODIMENTS

Preferred embodiments of the invention will be described hereinafter with reference to the accompanying drawings.

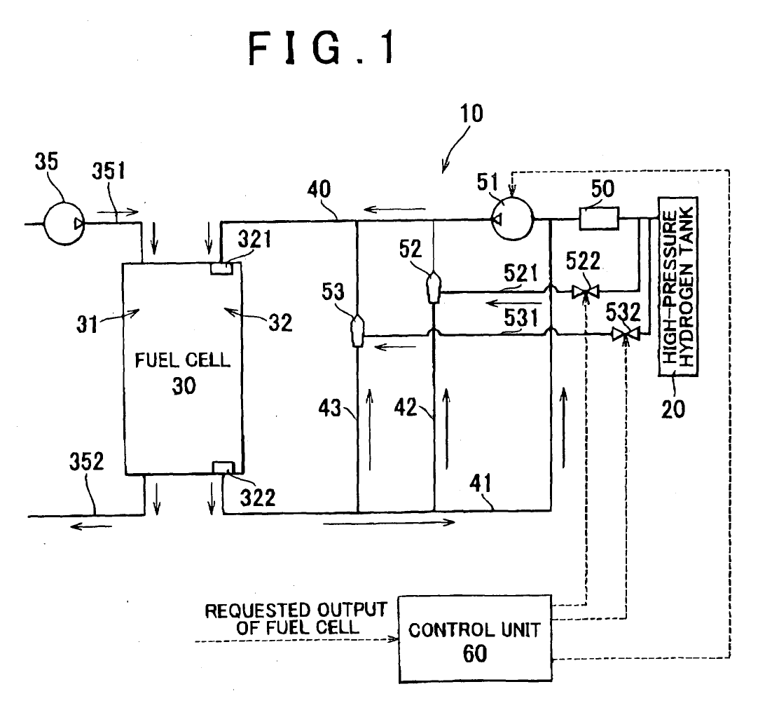

With reference to FIG. 1, a general construction of a hydrogen supply system in accordance with an embodiment of the invention will be described. FIG. 1 is a schematic diagram illustrating a construction of the hydrogen supply system of the embodiment. The hydrogen supply system 10 includes a high-pressure hydrogen tank 20, a fuel cell 30, a hydrogen gas supply pipe 40, a first hydrogen gas circulation pipe 41, a second hydrogen gas circulation pipe 42, and a third hydrogen gas circulation pipe 43. The high-pressure hydrogen tank 20 stores pure hydrogen gas in a high-pressure state. The fuel cell 30 generates electric power by consuming hydrogen gas supplied. The hydrogen gas supply pipe 40 connects the high-pressure hydrogen tank 20 and the fuel cell 30 in communication. The first hydrogen gas circulation pipe 41, the second hydrogen gas circulation pipe 42, and the third hydrogen gas circulation pipe 43 conduct hydrogen-containing gas that contains the hydrogen that has been supplied to but has not been consumed by the fuel cell 30, back toward the fuel cell 30.

The high-pressure hydrogen tank 20 is, for example, a high-pressure vessel in which hydrogen gas is stored (charged) at a pressure of 230 kPa. The number of high-pressure hydrogen tanks 20 provided may be one or more than one in accordance with the required capacity for supplying hydrogen gas. If a plurality of high-pressure hydrogen tanks 20 are used, the high-pressure hydrogen tanks 20 are connected to a common hydrogen discharge pipe (not shown) so that hydrogen gas is discharged into the hydrogen gas supply pipe 40 via the hydrogen gas discharge pipe.

The fuel cell 30 is, for example, a solid polymer membrane type fuel cell, in which an air electrode 31 that receives air and a fuel electrode 32 that receives hydrogen gas are provided on opposite sides of a solid polymer membrane (not shown). The fuel electrode 32 is provided with a hydrogen gas supply opening 321 and a residual hydrogen discharge opening 322. The hydrogen gas supply opening 321 supplies the fuel electrode 32 with hydrogen gas supplied from the high-pressure hydrogen tank 20 via the hydrogen gas supply pipe 40. The residual hydrogen discharge opening 322 discharges hydrogen-containing gas that contains the hydrogen remaining unconsumed by the fuel electrode 32.

An air supply pipe 351 for supplying air that has been pressurized by an air blower 35 is connected to the air electrode 31. Also connected to the air electrode 31 is an air discharge pipe 352 for discharging air used on the air electrode 31 into the atmosphere.

The hydrogen in hydrogen gas supplied to the fuel electrode 32 is separated into hydrogen ions and electric charges by a catalyst provided on the solid polymer membrane. The hydrogen ions migrate to the air electrode 31 through the solid polymer membrane whereas the electric charges migrate to the air electrode 31 via an external circuit. On the air electrode 31, air supplied (oxygen acting as an oxidizer), hydrogen ions migrating to the air electrode 31 via the solid polymer membrane, and the electric charges react, generating water. Hydrogen-containing gas that contains the hydrogen remaining unconsumed by the fuel electrode 32 is discharged from the residual hydrogen discharge opening 322 toward the first to third hydrogen gas circulation pipes 41 to 43.

An end (upstream side) of the hydrogen gas supply pipe 40 is connected to a discharge opening 21 of the high-pressure hydrogen tank 20. Another end (downstream side) of the hydrogen gas supply pipe 40 is connected to the hydrogen gas supply opening 321. Disposed on an upstream-side portion of the hydrogen gas supply pipe 40 is a pressure reducer 50 for reducing the pressure of hydrogen gas discharged from the high-pressure hydrogen tank 20 to, for example, about 1 kPa. Disposed on the hydrogen gas supply pipe 40 downstream of the pressure reducer 50 is a mechanical circulating pump 51 for moving a fluid (hydrogen-containing gas) in the hydrogen gas supply pipe 40. The circulating pump 51 is, for example, an electrically driven type pump that operates in accordance with a control signal. The circulating pump 51 can be disposed on the first hydrogen gas circulation pipe 41 if the circulating pump 51 can moves the hydrogen-containing gas, not apply only to the hydrogen gas supply pipe 40.

The first hydrogen gas circulation pipe 41 is connected at an end thereof (upstream side) to the residual hydrogen discharge opening 322, and is connected at another end thereof (downstream side) to the hydrogen gas supply pipe 40 between the pressure reducer 50 and the circulating pump 51. Therefore, the hydrogen-containing gas from the first hydrogen gas circulation pipe 41 is re-supplied by the circulating pump 51 to the fuel electrode 32 of the fuel cell 30 via the hydrogen gas supply opening 321.

An end (upstream side) of each of the second and third hydrogen gas circulation pipes 42, 43 is connected to an upstream-side portion of the first hydrogen gas circulation pipe 41. Another end (downstream side) of each of the second and third hydrogen gas circulation pipes 42, 43 is connected to the hydrogen gas supply pipe 40 downstream of the circulating pump 51. First and second ejectors 52, 53 are provided in the second and third hydrogen gas circulation pipes 42, 43, respectively, for moving the hydrogen-containing gas in the second and third hydrogen gas circulation pipes 42, 43.

The first and second ejectors 52, 53 are momentum transfer type pumps that transport gas on the basis of an entrainment effect of the operating fluid jetted from a nozzle portion at high speed. In this embodiment, high-pressure hydrogen gas is used as an operating fluid (drive power source) jetted from a nozzle portion at high speed, and the transportation of hydrogen-containing gas in the second and third hydrogen gas circulation pipes 42, 43 is achieved by the entrainment effect caused by the high-pressure hydrogen gas. The first and second ejectors 52, 53 are connected to the high-pressure hydrogen tank 20 via operating fluid introducing pipes 521, 531, respectively, for conducting high-pressure hydrogen gas. The operating fluid introducing pipes 521, 531 are provided with first and second control valves 522, 532, respectively, for allowing and stopping the supply of high-pressure hydrogen gas to the first and second ejectors 52, 53. Each of the first and second control valves 522, 532 is, for example, a control valve that is opened and closed by an electromagnetic actuator that operates in accordance with a control signal. The first and second ejectors 52, 53 can be provided on the hydrogen gas supply pipe 40, not apply only to the second and third hydrogen gas circulation pipes 42, 43 respectively.

In this embodiment, since high-pressure hydrogen gas is used as the operating fluid of the ejectors 52, 53, there is no need to pressurize hydrogen gas serving as the operating fluid at the time of jetting hydrogen gas from the nozzle portions. As a matter of fact, energy stored in the high-pressure hydrogen gas at the time of compressing and charging high-pressure hydrogen gas into the high-pressure hydrogen tank 20 is utilized as kinetic energy (pressure energy) for transporting gas, whereas in the related-art technology, such energy stored in highly pressurized hydrogen gas is wasted in the form of thermal energy at a pressure control valve. Therefore, the embodiment reduces the energy needed for moving hydrogen-containing gas, and utilizes the energy that is wasted in the related-art technology, thus improving the energy efficiency of the system as a whole.

A control unit 60 is provided as a unit for controlling the state of operation of the hydrogen supply system 10 of the embodiment, and has a calculating function, a memory function, etc. The control unit 60 is connected to the circulating pump 51, and the first and second control valves 522, 532, via control lines. In accordance with an output request regarding the fuel cell 30, the control unit 60 outputs control signals to the circulating pump 51 and the first and second control valves 522, 532 to control the states of operation thereof so as to adjust the amount of hydrogen gas circulated in the hydrogen supply system 10.

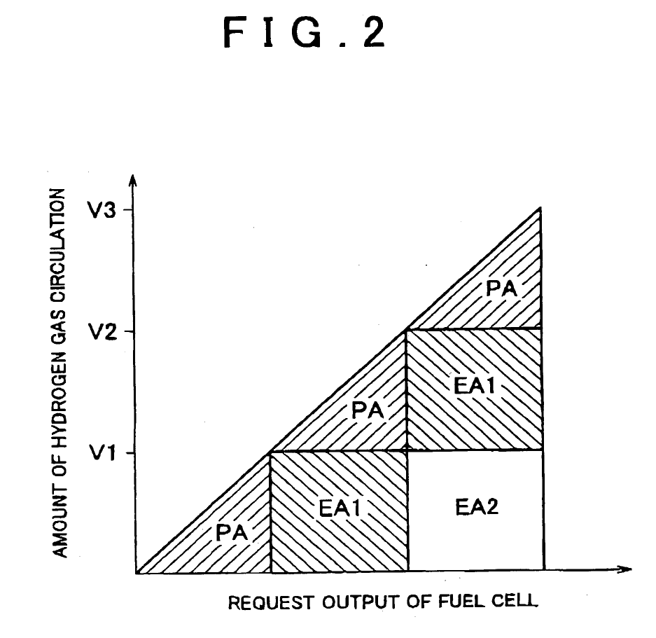

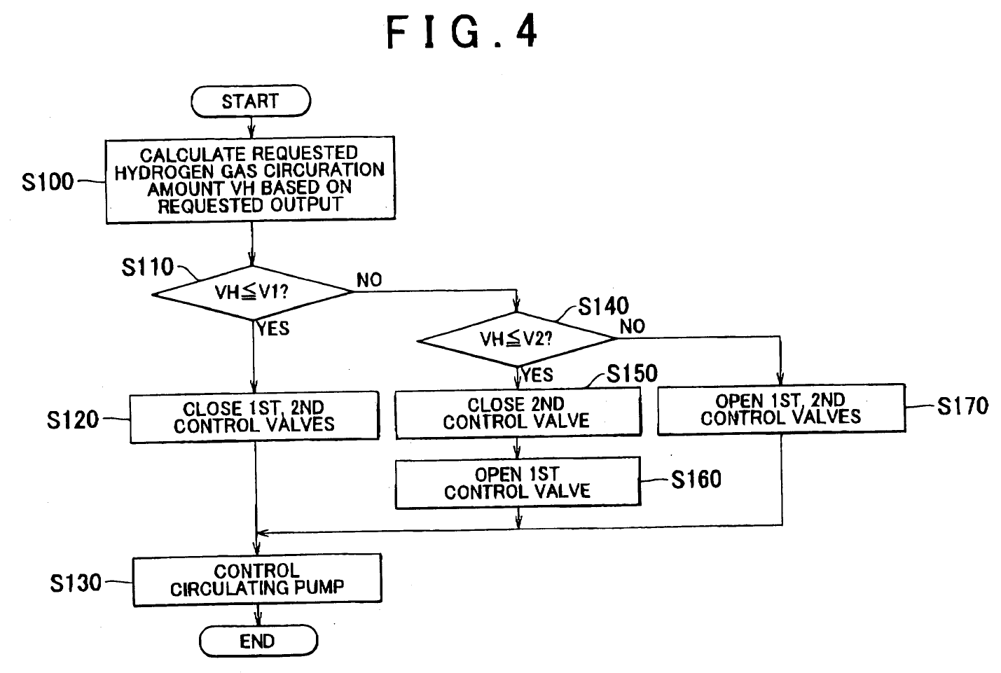

With reference to FIGS. 2 to 4, operation of the hydrogen supply system 10 in accordance with the embodiment will be described. FIG. 2 is a graph indicating a relationship between the requested output of the fuel cell and the amount of hydrogen gas circulation. FIG. 2 is a timing chart indicating drive signals output from the control unit 60 to the circulating pump 51 and the control valves 522, 532 corresponding to the requested amount of hydrogen gas circulation. FIG. 4 is a flowchart illustrating a process routine of changing the states of operation of the circulating pump 51 and the first and second ejectors 52, 53 in the hydrogen supply system 10 in accordance with the embodiment.

The hydrogen supply system 10 of the embodiment is designed so that the maximum amount of hydrogen gas circulation in the hydrogen supply system 10 is equal to the total amount of circulation caused by the three pumps, that is, the circulating pump 51 and the ejectors 52, 53 as indicated in FIG. 2. In FIG. 2, the amount of hydrogen gas circulation caused by the circulating pump 51 is indicated in regions PA, and the amount of hydrogen gas circulation caused by the first ejector 52 is indicated in regions EA1, and the amount of hydrogen gas circulation caused by the second ejector 53 is indicated in a region EA2.

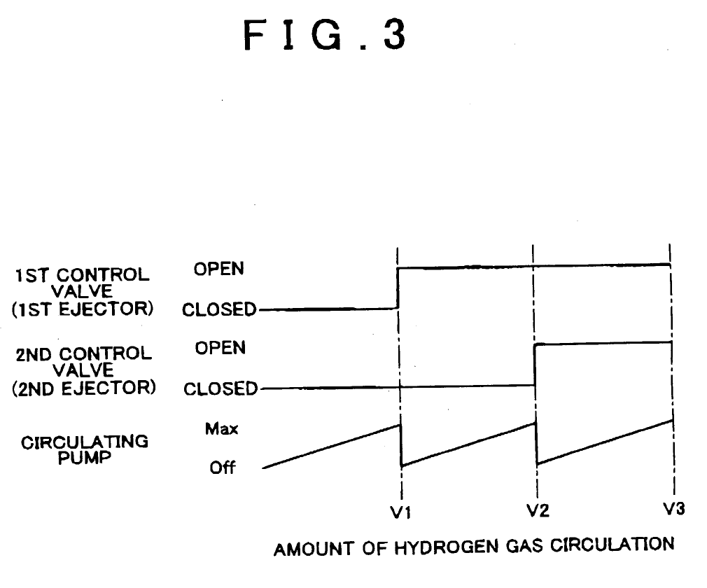

The circulating pump 51 is capable of variably adjusting the amount of hydrogen gas circulation whereas the first and second ejectors 52, 53, due to their construction, are not capable of adjusting the amount of hydrogen gas circulation, but is able to provide fixed amounts of hydrogen gas circulation. In this embodiment, if the requested amount of hydrogen gas circulation VH is less than or equal to a first circulation amount V1, the first and second ejectors 52, 53 remain unoperated, and only the circulating pump 51 is used to circulate hydrogen-containing gas, as indicated in FIGS. 2 and 3. If the requested amount of hydrogen gas circulation VH exceeds the first circulation amount V1, the first control valve 522 is opened so that the first ejector 52 circulates the circulation amount V1 of hydrogen-containing gas, and in addition, a circulation amount of hydrogen-containing gas, which is more than the circulation amount V1 and which is less than or equal to a circulation amount V2, is circulated by the circulating pump 51. If the requested amount of hydrogen gas circulation VH exceeds the circulation amount V2, the second control valve 532 is opened in addition to the first control valve 522 so that the first and second ejectors 52, 53 circulate the circulation amount V2 of hydrogen-containing gas, and in addition, a circulation amount of hydrogen-containing gas, which is more than the circulation amount V2 and which is less than or equal to a circulation amount V3, is circulated by the circulating pump 51.

It is to be noted herein that the hydrogen-containing gas circulated by the circulating pump 51 contains residual hydrogen discharged from the fuel cell 30 without being consumed, and also contains an amount of pure hydrogen supplied from the high-pressure hydrogen tank 20 corresponding to the amount of hydrogen consumed by the fuel cell 30. That is, as hydrogen is consumed by the fuel cell 30, the pressure in the hydrogen gas supply pipe 40 drops by a partial pressure of the amount of hydrogen consumed by the fuel cell 30. Therefore, an amount of pure hydrogen corresponding to the partial pressure of the amount of hydrogen consumed is supplied from the high-pressure hydrogen tank 20 via the pressure reducer 50. The hydrogen-containing gas circulated by the first and second ejectors 52, 53 contains an amount of pure hydrogen supplied as high-pressure hydrogen gas from the high-pressure hydrogen tank 20 which partly corresponds to the amount of hydrogen consumed by the fuel cell 30 and which is partly provided as an operating fluid, in addition to residual hydrogen discharged from the fuel cell 30 without being consumed. The amount of hydrogen gas circulation supplied to the fuel cell 30 is set at about 1.5 times the amount of hydrogen gas consumed for electric power generation by the fuel cell 30, in order to prevent, for example, closure of flow paths by water generated in the fuel cell 30 in connection with power generation, and to ensure constant power generation efficiency.

With reference to FIG. 4, a process of changing the states of operation of the circulating pump 51 and the first and second ejectors 52, 53 will be described. This process routine is cyclically executed by the control unit 60 at every elapse of a predetermined time. First, the control unit 60 computes a requested amount of hydrogen gas circulation VH needed on the basis of a requested fuel cell output that is input as a request regarding the fuel cell 30 (step S100). The amount of hydrogen gas circulation corresponding to the requested fuel cell output can be determined, for example, through the use of a map indicated in FIG. 2. At the time of an initial execution of this process routine, the first control valve 522 and the second control valve 532 are in a closed state.

Subsequently, the control unit 60 determines whether the requested hydrogen gas circulation amount VH computed is at most the circulation amount V1 (step S110). The circulation amount V1 corresponds to the maximum circulation amount that can be provided by the first ejector 52. If it is determined that VH≦V1 (YES at step S110), the control unit 60 closes the first control valve 522 and the second control valve 532 (step S120). As a result, the first and second ejectors 52, 53 do not operate. After that, the control unit 60 controls the amount of ejection from the circulating pump 51 in accordance with the requested hydrogen gas circulation amount VH (step S130), and then ends the process routine. Therefore, the hydrogen-containing gas in the first hydrogen gas circulation pipe 41 and the hydrogen gas supply pipe 40 is delivered to the hydrogen gas supply opening 321 of the fuel cell 30 via the circulating pump 51.

If it is determined that VH>V1 (NO at step S110), the control unit 60 determines whether the requested hydrogen gas circulation amount VH computed is at most the circulation amount V2 (step S140). The circulation amount V2 corresponds to a maximum circulation amount that can be provided by the first ejector 52 and the second ejector 53. If it is determined that VH≦V2 (YES at step S140), the control unit 60 closes the second control valve 532 (step S150), and opens the first control valve 522 (step S160). As a result, of the requested hydrogen gas circulation amount VH, the circulation amount V1 of hydrogen-containing gas is delivered by the first ejector 52 to the hydrogen gas supply opening 321 of the fuel cell 30 via the second hydrogen gas circulation pipe 42 and the hydrogen gas supply pipe 40. The control unit 60 controls the amount of ejection from the circulating pump 51 in accordance with an excess circulation amount, that is, an amount obtained by subtracting the circulation amount V1 from the requested hydrogen gas circulation amount VH (step S130). After that, the control unit 60 ends the process routine. Therefore, the excess circulation amount of hydrogen-containing gas equal to the requested hydrogen gas circulation amount VH minus the circulation amount V1 is delivered by the circulating pump 51 to the hydrogen gas supply opening 321 of the fuel cell 30 via the first hydrogen gas circulation pipe 41 and the hydrogen gas supply pipe 40.

If it is determined that VH>V2 (NO at step S140), the control unit 60 opens the first and second control valves 522, 532 (step S170). As a result, of die requested hydrogen gas circulation amount VH, the circulation amount V2 of hydrogen-containing gas is delivered by the first and second ejectors 52, 53 to the hydrogen gas supply opening 321 of the fuel cell 30 via the second and third hydrogen gas circulation pipes 42, 43 and the hydrogen gas supply pipe 40. In accordance with the excess amount of circulation, that is, an amount obtained by subtracting the circulation amount V2 from the requested hydrogen gas circulation amount VH, the control unit 60 controls the amount of ejection from the circulating pump 51 (step S130). Then, the control unit 60 ends the process routine. Therefore, the excess circulation amount of hydrogen-containing gas equal to the requested hydrogen gas circulation amount VH minus the circulation amount V2 is delivered by the circulating pump 51 to the hydrogen gas supply opening 321 of the fuel cell 30 via the first hydrogen gas circulation pipe 41 and the hydrogen gas supply pipe 40.

As described above, according to the hydrogen supply system 10 of the embodiment, the maximum amount of hydrogen gas circulation of the system is provided by the three pumps, that is, the electrically driven mechanical circulating pump 51, and the first and second ejectors 52, 53 driven by high-pressure hydrogen gas supplied from the high-pressure hydrogen tank 20. Therefore, the amount of ejection (circulation amount) requested of each of the pumps 51, 52, 53 can be reduced, and the electric power consumed by the circulating pump 51 can be reduced. Furthermore, since the first and second ejectors 52, 53 are driven by high-pressure hydrogen gas instead of electric power or the like. Therefore by driving the first and second ejectors 52, 53 preferentially, the electric power (drive power) consumed by the hydrogen supply system 10 to supply hydrogen gas can be reduced.

In general, as the amount of electric power generated by the fuel cell 30 increases, the requested hydrogen gas circulation amount also increases. Therefore, a fuel cell system equipped with only a mechanical pump tends to suffer a considerably large proportion of the electric power consumed for circulation of hydrogen-containing gas to the entire amount of electric power generated by the fuel cell 30. However, the hydrogen supply system 10 of the embodiment is equipped with the circulating pump 51 of small electric power consumption, and the ejectors 52, 53 that need no electric power for circulating hydrogen-containing gas. Therefore, the system 10 is able to highly efficiently supply electric power generated by the fuel cell 30 to an external circuit.

Furthermore, the energy that is employed in charging the high-pressure hydrogen tank 20 with high-pressure hydrogen gas and is then wasted in the form of thermal energy at the nozzle portion of the pressure control valve in the related-art technology is utilized as kinetic energy for circulating hydrogen-containing gas in the hydrogen supply system 10 of the embodiment. Therefore, the energy efficiency of the hydrogen supply system 10 as a whole can be improved.

Still further, the ejectors 52, 53 have a simple structure without any movable portion, and therefore have an advantage of easy maintenance of performance. Furthermore, since the ejectors 52, 53 are disposed within the second and third hydrogen gas circulation pipes 42, 43, it is possible to reduce the noise caused in relation to suction, which often becomes a problem in existing ejectors.

In the embodiment, the hydrogen-containing gas that flows in the first to third hydrogen gas circulation pipes 41 to 43 is supplied to the fuel cell 30 via the hydrogen gas supply pipe 40. Therefore, the unification of pipes into a common pipe allows a size reduction of the system. In addition, the circulating pump 51 of a mechanical type is disposed downstream of the pressure reducer 50, and performs a valve function. Therefore, the pressure reducer 50 may be a simple pressure reducer that does not have a valve function.

While the hydrogen supply system of the invention has been described with reference to the preferred embodiment, the foregoing embodiment of the invention is merely for illustration of the invention, and does not limit the invention. On the contrary, it is to be understood that the invention is intended to cover various modifications and equivalent arrangements made without departing from the sprit and scope of the invention.

### Other Embodiments

Although the foregoing embodiment includes three pumps in total, that is, the circulating pump 51 and the first and second ejectors 52, 53, it is also possible to employ a plurality of circulating pumps capable of adjusting the amount of circulation and employ a single ejector or more than two ejectors. In such a case, finer adjustment of the amount of circulation of hydrogen-containing gas can be performed by the mechanical pumps capable of adjusting the amount of circulation. Since the amount of circulation provided by an ejector is fixed, provision of a plurality of circulating pumps allows finer variable control of the amount of circulation. Furthermore, provision of a plurality of ejectors will also allow finer control of amount of circulation.

Although in the foregoing embodiment, the circulating pump 53 is disposed in the hydrogen gas supply pipe 40, the circulating pump 51 may instead be disposed in the first hydrogen gas circulation pipe 41. In that case, the pressure reducer 50 needs to have a valve function of allowing and stopping the supply of high-pressure hydrogen gas from the high-pressure hydrogen tank 20, in addition to the pressure reducing function.

Although in the foregoing embodiment, the hydrogen-containing gas in the first to third hydrogen gas circulation pipes 41 lo 43 is supplied to the fuel cell 30 via the hydrogen gas supply pipe 40, the first to third hydrogen gas circulation pipes 41 to 43 may be individually connected to the hydrogen gas supply opening 321 and the residual hydrogen gas discharge opening 322 of the fuel cell 30, separately from the hydrogen gas supply pipe 40.

The values of pressure of high-pressure hydrogen gas and hydrogen-containing gas (circulating hydrogen gas) mentioned in conjunction with the foregoing embodiment arc mere examples. It is possible to adopt any pressure values suitable to individual systems.

What is claimed is:

1. A hydrogen supply system comprising:
a hydrogen-consuming device;
a high-pressure hydrogen gas storage that stores a hydrogen gas in a high-pressure state;
a hydrogen gas passage that conducts the hydrogen gas discharged from the high-pressure hydrogen gas storage to the hydrogen-consuming device;
a first circulation passage that is connected to the hydrogen gas passage, and that conducts a hydrogen-containing gas that contains residual hydrogen not consumed by the hydrogen-consuming device back to the hydrogen-consuming device;
a mechanical pump that is disposed on at least one of the hydrogen gas passage and the first circulation passage, and that moves the hydrogen-containing gas in the first circulation passage;
a second circulation passage that is connected to the hydrogen gas passage, and that conducts a hydrogen-containing gas that contains residual hydrogen not consumed by the hydrogen-consuming device back to the hydrogen-consuming device;
a first momentum transfer type vacuum pump that is disposed on at least one of the hydrogen gas passage and the second circulation passage, and that moves the hydrogen-containing gas in the second circulation passage by utilizing the hydrogen gas discharged from the high-pressure hydrogen gas storage as a drive flow; and
a control unit that controls a state of operation of the mechanical pump and a state of operation of the first momentum transfer type vacuum pump in accordance with an amount of hydrogen consumed by the hydrogen-consuming device.

2. The hydrogen supply system according to claim 1,
wherein a plurality of first circulation passages and a plurality of mechanical pumps are provided, and
wherein the control unit controls the states of operation of the plurality of mechanical pumps and the state of operation of the first momentum transfer type vacuum pump in accordance with the amount of hydrogen consumed by the hydrogen-consuming device.

3. The hydrogen supply system according to claim 1,
wherein a plurality of second circulation passages and a plurality of first momentum transfer type vacuum pumps are provided, and
wherein the control unit controls the state of operation of the mechanical pump and the states of operation of the plurality of first momentum transfer type vacuum pumps in accordance with the amount of hydrogen consumed by the hydrogen-consuming device.

4. The hydrogen supply system according to claim 3,
wherein a plurality of first circulation passages and a plurality of mechanical pumps are provided, and
wherein the control unit controls the states of operation of the plurality of mechanical pumps and the states of operation of the plurality of first momentum transfer type vacuum pumps in accordance with the amount of hydrogen consumed by the hydrogen-consuming device.

5. The hydrogen supply system according to claim 1, further comprising:
a third circulation passage that is disposed in parallel to the second circulation passage and that conducts a hydrogen-containing gas that contains residual hydrogen not consumed by the hydrogen-consuming device back to the hydrogen-consuming device;
a second momentum transfer type vacuum pump that is disposed on at least one of the hydrogen gas passage and the third circulation passage, and that moves the hydrogen-containing gas in the third circulation passage by utilizing the hydrogen gas discharged from the high-pressure hydrogen gas storage as a drive flow;
a first operating fluid introducing pipe that conducts a high-pressure hydrogen gas to the first momentum transfer type vacuum pump;
a second operating fluid introducing pipe that conducts a high-pressure hydrogen gas to the second momentum transfer type vacuum pump;
a first control valve disposed on the first operating fluid introducing pipe that controls a state of operation of the first momentum transfer type vacuum pump, and
a second control valve disposed on the second operating fluid introducing pipe that controls a state of operation of the second momentum transfer type vacuum pump;
wherein
the control unit that controls the first momentum transfer type vacuum pump and the second momentum transfer type vacuum pump via the first control valve and the second control valve respectively in accordance with an amount of hydrogen consumed by the hydrogen-consuming device.

6. A hydrogen supply system comprising:
a hydrogen-consuming device having a hydrogen gas supply opening and a residual hydrogen gas discharge opening for discharging a hydrogen-containing gas that contains residual hydrogen not consumed;
a high-pressure hydrogen gas storage that stores a hydrogen gas in a high-pressure state,
a hydrogen gas supply pipe that connects the high-pressure hydrogen gas storage and the hydrogen gas supply opening of the hydrogen-consuming device;
a first hydrogen gas circulation pipe that is connected to the hydrogen gas supply pipe, and that connects the residual hydrogen gas discharge opening of the hydrogen-consuming device and the hydrogen gas supply pipe;
a mechanical pump that is disposed on the hydrogen gas supply pipe and that moves a fluid in the first hydrogen gas circulation pipe and the hydrogen gas supply pipe;
a second hydrogen gas circulation pipe that is disposed in parallel to the first hydrogen gas circulation pipe and that connects the hydrogen gas supply pipe and the residual hydrogen gas discharge opening of the hydrogen-consuming device;
a momentum transfer type vacuum pump that is disposed on the second hydrogen gas circulation pipe and that moves a fluid in the second hydrogen gas circulation pipe and the hydrogen gas supply pipe by utilizing the hydrogen gas discharged from the high-pressure hydrogen gas storage as a drive flow; and
a control unit that controls a state of operation of the mechanical pump and a state of operation of the momentum transfer type vacuum pump in accordance with an amount of hydrogen consumed by the hydrogen-consuming device.

7. The hydrogen supply system according to claim 6,
wherein a plurality of first hydrogen gas circulation pipes and a plurality of mechanical pumps are provided, and
wherein the control unit controls the states of operation of the plurality of mechanical pumps and the state of operation of the momentum transfer type vacuum pump in accordance with the amount of hydrogen consumed by the hydrogen-consuming device.

8. The hydrogen supply system according to claim 7, wherein the hydrogen-consuming device is a fuel cell, and the momentum transfer type vacuum pump is an ejector.

9. The hydrogen supply system according to claim 6, wherein the hydrogen-consuming device is a fuel cell, and the momentum transfer type vacuum pump is an ejector.

10. The hydrogen supply system according to claim 6,
wherein a plurality of second hydrogen gas circulation pipes and a plurality of momentum transfer type vacuum pumps are provided, and
wherein the control unit controls the state of operation of the mechanical pump and the states of operation of the plurality of momentum transfer type vacuum pumps in accordance with the amount of hydrogen consumed by the hydrogen-consuming device.

11. The hydrogen supply system according to claim 10, wherein the hydrogen-consuming device is a fuel cell, and the momentum transfer type vacuum pumps are ejectors.

12. The hydrogen supply system according to claim 10,
wherein a plurality of first hydrogen gas circulation pipes and a plurality of mechanical pumps are provided, and
wherein the control unit controls the states of operation of the plurality of mechanical pumps and the states of operation of the plurality of momentum transfer type vacuum pumps in accordance with the amount of hydrogen consumed by the hydrogen-consuming device.

13. The hydrogen supply system according to claim 12, wherein the hydrogen-consuming device is a fuel cell, and the momentum transfer type vacuum pumps are ejectors.

14. The hydrogen supply system according to claim 6, further comprising a pressure reducing mechanism disposed on the hydrogen gas supply pipe,
wherein the mechanical pump is disposed on the hydrogen, gas supply pipe downstream of the pressure reducing mechanism.

15. The hydrogen supply system according to claim 6, further comprising:
an operating fluid introducing pipe that conducts a high-pressure hydrogen gas to the momentum transfer type vacuum pump; and
a control valve disposed on the operating fluid introducing pipe,
wherein the control unit controls a state of operation of the momentum transfer type vacuum pump by controlling the control valve.

16. A control method for a hydrogen supply system that has: a hydrogen-consuming device; a high-pressure hydrogen gas storage that stores a hydrogen gas in a high-pressure state; a first circulation passage and a second circulation passage that conduct a hydrogen-containing gas that contains residual hydrogen not consumed by the hydrogen-consuming device back to the hydrogen-consuming device,
the control method comprising:
calculating a hydrogen consumption amount consumed by the hydrogen-consuming device;
comparing the calculated hydrogen consumption amount with a maximum circulation amount of the second circulation passage whose energy consumption for circulating the hydrogen-containing gas is less than an energy consumption for circulating the hydrogen-containing gas of the first circulation passage;
allowing at least a flow in the second circulation passage regardless of the maximum circulation amount of the first circulation passage, if a result of the comparison is that the hydrogen consumption amount is equal to or greater than the maximum circulation amount of the second circulation passage.

17. The control method according to claim 16,
the hydrogen supply system provided an operating fluid introducing pipe that connects the second circulation passage and the high-pressure hydrogen gas storage and a control valve disposed on the operating fluid introducing pipe,
wherein a flow in the first circulation passage is caused by a mechanical pump, and
wherein a flow in the second circulation passage is caused by a momentum transfer type vacuum pump that is operated by the control valve.

18. A control method for a hydrogen supply system that has:
a hydrogen-consuming device;
a high-pressure hydrogen gas storage that stores a hydrogen gas in a high-pressure state; and
a first circulation passage, a second circulation passage and a third circulation passage that conducts a hydrogen-containing gas that contains residual hydrogen not consumed by the hydrogen-consuming device back to the hydrogen-consuming device;
the control method comprising:
calculating a hydrogen consumption amount consumed by the hydrogen-consuming device;
comparing the hydrogen consumption amount calculated with a maximum circulation amount of the second circulation passage whose energy consumption for circulating the hydrogen-containing gas is less than an energy consumption for circulating the hydrogen-containing gas of the first circulation passage and a maximum circulation amount of the third circulation passage whose energy consumption for circulating the hydrogen-containing gas is less than an energy consumption for circulating the hydrogen-containing gas of the first circulation passage, and whose the maximum circulation amount of the third circulation passage is greater than the maximum circulation amount of the second circulation passage;
allowing a flow in at least the second circulation passage, if a result of the comparison is that the hydrogen consumption amount is greater than the maximum circulation amount of the second circulation passage, and is less than or equal to the maximum circulation amount of the third circulation passage;
allowing a flow in at least one of the second circulation passage and the third circulation passage, if a result of the comparison is that the hydrogen consumption amount is greater than the maximum circulation amount of the third circulation passage,
allowing a flow in at least the second circulation passage and the third circulation passage, if a result of the comparison is that the hydrogen consumption amount is greater than a total of the maximum circulation amount of the second circulation passage and the maximum circulation amount of the third circulation passage.

19. The control method according to claim 18,
the hydrogen supply system provided a first operating fluid introducing pipe that connects the second circulation passage and the high-pressure hydrogen gas storage, a first control valve disposed on the first operating fluid introducing pipe, a second operating fluid introducing pipe that connects the third circulation passage and the high-pressure hydrogen gas storage and a second control valve disposed on the second operating fluid introducing pipe,
wherein a flow in the first circulation passage is caused by a mechanical pump, and
wherein a flow in the second circulation passage and the third circulation passage is caused by a momentum transfer type vacuum pump that is operated by the first control valve and the second control valve.
